(19) United States
(12) Patent Application Publication
(10) Pub. No.: US 2008/0034147 A1
(43) Pub. Date: Feb. 7, 2008

(54) Method and system for transferring packets between devices connected to a PCI-Express bus

(76) Inventors: Robert Stubbs, Longmont, CO (US); John Kloeppner, Buhler, KS (US); Dennis Gates, Wichita, KS (US)

Correspondence Address: Pete Scott, Senior Corporate Counsel;LSI Logic Corporation, Legal Department - IP, 1621 Barber Lane, MS D-106, Milpitas, CA, 95035, US

(21) Appl. No.: 11/496,858

(22) Filed: Aug. 1, 2006

(51) Int. Cl. G06F 13/36

(52) U.S. Cl. 710/315

(57) ABSTRACT

A method, system and computer program for transferring packets between devices connected to a PCI-Express bus of a computer. A selected pair of devices, such as for example a root complex device and an endpoint device or a pair of endpoint devices, connected to the PCI-Express bus, are configured to transmit/receive data with their respective maximum payload size (MPS). A packet, such as for example a read completion packet, a write memory packet or a message request packet, can then be transmitted from the source device to the destination device. If the source device MPS exceeds the destination device MPS, the packet can be divided into a plurality of sub-packets. Each of sub packets has a maxmimum payload size based on the MPS of the destination device. The sub-packets can then be transmitted to the destination device so that the packet can be delivered to the destination device.

### TECHNICAL FIELD

Embodiments relate to methods and systems for transferring data and, more particularly, to systems and methods for transferring packets between devices connected to a PCI Express bus system. Additionally, embodiments relate to systems and methods for transferring packets between a selected root complex device and an endpoint device pair or between a pair of endpoint devices.

### BACKGROUND

Peripheral Component Interconnect (PCI) local bus is a common input/output (I/O) bus standard developed for computer systems. Input/output I/O processing on the PCI bus and physical connectivity between servers and storage devices permits transfer of 32 or 64 bit data at clock speeds of 33 MHz or 66 MHz.

PCI-X bus, an enhancement to conventional PCI bus specification, increases bus capacity enabling systems and devices to operate at bus frequencies above 66 MHz and up to 133 MHz using 32 or 64 bit bus width.

Unfortunately, the performance of computer systems employing PCI & PCI-X architecture is limited by the bandwidth of the parallel bus making it difficult for typical desktop and mobile machines to meet ever increasing data transfer rates required to run complex software applications. For example, multi-media applications now require multiple data to be streamed from various video and audio sources and transferred concurrently via the I/O system. Many server communications applications such as video-on-demand are also now demanding higher speed data transfer.

Consequently, a higher performance I/O interconnect, known as PCI Express Architecture, is emerging as a local I/O bus for a wide variety of future computing platforms. Unlike PCI/PCI-X buses which implement a bandwidth-limiting, parallel bus implementation, PCI Express utilizes a long-life, fully-serial interface which performs serial data transfers starting with a base transfer rate of 2.5 Gb/second. A PCI Express multiple connection, serial bus topology typically contains several endpoints (the I/O devices) connected via a switch to a root complex device. A split-transaction protocol is implemented with attributed packets that are prioritized and optimally routed via the switch for delivery to their target. Transfers are full duplex so that data can flow to and from a device simultaneously. Since data is switched, more than one device can be transferring at the same time. The switch may provide peer-to-peer communication between different endpoints without forwarding to the root complex. The PCI Express Architecture comprehends a variety of form factors to support smooth integration with PCI and to enable new system form factors.

The PCI Express Architecture is specified in logical layers but compatibility with the PCI addressing model is maintained to ensure that all existing applications and drivers operate unchanged. PCI Express configuration uses standard mechanisms as defined in the PCI Plug-and-Play specification. The software layers generate read and write requests that are transported by the transaction layer to the I/O devices using a packet-based, split-transaction protocol. The link layer adds sequence numbers and a Cyclic Redundancy Check (CRC) to these packets to create a highly reliable data transfer mechanism.

Despite the higher performance achievable by PCI Express I/O interconnects, current and future software applications are demanding yet higher data transfer performance from the I/O bus system. There is, therefore, a need to improve the data transfer performance of the PCI-Express bus.

The embodiments disclosed herein therefore directly address the shortcomings of known PCI Express bus systems by providing an improved system and method for transferring data between devices connected to a PCI-Express bus system.

### BRIEF SUMMARY

It is therefore one aspect of the embodiments to provide an improved method for transferring data between devices connected to a PCI-Express bus system.

It is another aspect of the embodiments to provide an improved system for transferring data between devices connected to a PCI-Express bus system.

It is also another aspect of the embodiments to provide a computer program, which when run on a computer, performs an improved method of transferring data between devices connected to a PCI-Express bus system.

The aforementioned aspects and other objectives and advantages can now be achieved as described herein. In one aspect, a method of transferring packets between devices connected to a PCI-Express bus of a computer is provided. According to the method, a pair of devices, connected to the PCI-Express bus, is selected. The selected pair comprises a source device and a destination device, such as for example a root complex device and an endpoint device or a pair of endpoint devices. The source device and destination device are configured to transmit/receive data with the maximum payload size (MPS) supported by the source device and destination device, respectively. A packet, such as for example a read completion packet, a write memory packet or a message request packet, can then be transmitted from the source device to the destination device. If the source device MPS exceeds the destination device MPS, the packet can be divided into a plurality of sub-packets. Each of the sub packets has a maximum payload size based on the MPS of the destination device. The sub-packets can then be transmitted to the destination device so that the packet can be delivered to the destination device.

By configuring a pair of devices to transmit/receive packets with the respective MPS of the devices and dividing the packet being switched into sub packets based on the destination device MPS if the source device MPS exceeds the destination device MPS, the method enables devices supporting different MPS to transmit/receive data with their different MPS. The packet transfer method is no longer restricted to transferring data with payload sizes which are smaller than can be supported by some of the devices.

Thus, the method enables packets of data to be selectively switched between a source device, such as root complex device, and a destination device, such as endpoint device, in a manner that enhances the data transfer performance of the PCI-Express bus system.

In order to divide the packet into the plurality of sub packets, the packet can be stored in a respective packet divider to provide the plurality of sub packets. The sub packets preferably each have a payload size equal to the MPS of the destination device. The packet divider can have a port for receiving the packet from the source device and another port for transmitting the packet or sub-packets to the destination device. The method can further comprise configuring the MPS of the packer divider port for receiving the packet to equal the MPS of the source device and configuring the MPS of the packet divider port for transmitting the packet or sub-packets to equal the MPS of the destination device. Additionally the method can comprise, storing the packet in the packet divider by transmitting the packet from the source device to the packet divider port for receiving the packet and transmitting the packet or sub-packets to the destination device from the packet divider port for transmitting the packet.

The selected pair of devices can be interconnected via a PCI-Express switch device having the packet divider integrated therein. The switch device can have a switch port for receiving the packet from the source device and another switch port for transmitting the packet or sub packets to the destination device. The respective packet divider can comprise a buffer operably coupled to one of the switch ports.

The switch port for receiving the packet can be configured to equal the MPS of the source device and the switch port for transmitting the packet or sub-packets can be configured to equal the MPS of the destination device.

The packet can be stored in the packet divider by transmitting the packet from the source device to the packet buffer via the switch port for receiving the packet.

The sub-packets can be transmitted to the destination device by delivering the plurality of sub-packets from the packet buffer to the destination device via the switch port for transmitting the packet.

The pair of devices can be selected from a plurality of devices connected to the switch device. The plurality of devices can comprise a root complex device and a plurality of end point devices.

According to another aspect, a system for transferring packets between devices connected to a PCI-Express bus of a computer includes one or more pairs of devices and a PCI-Express switch for selectively switching a packet between the devices. The pair(s) of devices comprise(s) a source device and a destination device each configured to operate at their respective MPS. For example, a pair of devices can comprise a root complex device and an endpoint device or a pair of endpoint devices. A packet divider is operably coupled to or integrated in the PCI-Express switch for dividing the packet into a plurality of sub-packets for transmission to the destination device. The packet divider is configured to divide the packet sent thereto from the source device into a plurality of sub-packets if the source device MPS exceeds the destination device MPS. Each of the sub packets has a maximum payload size based on the MPS of the destination device.

By the system configuring a selected pair of devices to transfer packets with their respective MPS and dividing the packet being switched into sub packets based on the destination device MPS if the source device MPS exceeds the destination device MPS, the system can transfer packets based on the smallest MPS of the pair of devices. The system is no longer limited to having to transfer data with the smallest MPS of all the devices in the system. The resultant larger packet sizes contain less overhead than multiple smaller packets thus improving system performance.

Each of the sub packets can have a maximum payload size equal to the MPS of the destination device.

The PCI express switch can include switch ports for receiving and transmitting the packet. The devices can be respectively coupled to the switch ports. The packet divider can have one or more packet buffers. The packet buffer(s) can be operably coupled to one or more switch ports associated with device pair(s).

If the device pair(s) comprise(s) a root complex device and endpoint device or a pair of end point devices, the buffer(s) can be operably connected to the same switch port(s) as the endpoint device(s). The root complex can be operable to configure the MPS of the switch port for receiving the packet to equal the MPS of the source device. Also, the root complex can be operable to equal the MPS of the switch port for transmitting the packet to the MPS of the destination device.

According yet another aspect, a computer program product comprises: a computer-usable data carrier storing instructions that, when executed by a computer, cause the computer to perform a method of transferring packets between devices connected to a PCI-Express bus of the computer, the method comprising selecting a pair of the devices comprising a source device and a destination device; configuring the source device and the destination device to transmit/receive data with the maximum payload size (MPS) supported by the source device and destination device, respectively; and transmitting a packet from the source device to the destination device; wherein the step of transmitting the packet comprises dividing the packet into a plurality of sub-packets if the source device MPS exceeds the destination device MPS, each of the sub packets having a maximum payload size based on the MPS of the destination device, and transmitting the sub-packets to the destination device so that the packet is delivered to the destination device.

The step of dividing the packet into the plurality of sub packets can comprise storing the packet in a packet divider to provide the plurality of sub packets. The one or more sub packets can have a maximum payload size equal to the MPS of the destination device.

The method can further include interconnecting the selected pair of devices via a PCI-Express switch device having the packet divider integrated therein.

### BRIEF DESCRIPTION OF THE DRAWINGS

The accompanying figures, in which like reference numerals refer to identical or functionally similar elements throughout the separate views and which are incorporated in and form a part of the specification, further illustrate the embodiment, together with the background, brief summary, and detailed description, serve to explain the principles of the illustrative embodiment.

FIG. 1 illustrates a flow-diagram outlining a method for transferring data between devices connected to a PCI-X Express bus of a computer according to a preferred embodiment;

FIG. 2 illustrates a schematic diagram outlining the topology of a system suitable for implementing the method shown in FIG. 1;

FIG. 3 illustrates a schematic diagram showing the switch device of the system of FIG. 2 in more detail;

FIG. 4 illustrates a flow-diagram describing a method of operating the system of FIG. 2 to transfer data between devices connected to the PCI-Express bus according to one embodiment;

FIGS. 5-7 illustrate schematic diagrams showing typical examples of maximum payload size matching between device pairs of the system of FIG. 2;

FIG. 8 illustrates an example of a message request packet which can be transferred using the system of FIG. 2; and

FIG. 9 illustrates sub-packets following division of the message request packet of FIG. 8

### DETAILED DESCRIPTION

The illustrative embodiment provides an approach to transferring packets between devices connected to a PCI Express (PCIe) bus of a computer using a method and a system which ensures transfer of large packet sizes between the PCIe bus pairs that have large Maximum Payload Size (MPS) where performance is important, while still allowing accesses to busses that have small Maximum Payload Size (MPS) where performance may be less important.

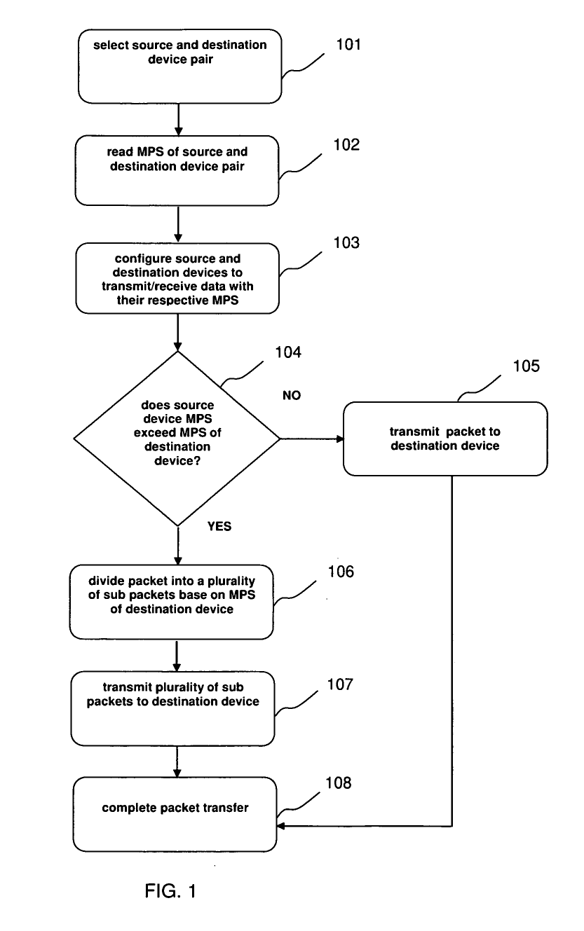

FIG. 1 of the accompanying drawings illustrates a flow-diagram outlining a method for transferring data between devices connected to a PCI-X Express bus of a computer according to one embodiment. As a general overview, the method 100 of transferring packets is initiated by selecting a source and destination device pair, such as for example a root complex device and an endpoint device, connected to the PCI-X Express bus, as indicated in step 101. The MPS supported by each of the selected source and destination devices are read and the devices are configured to transmit/receive packets with their respective MPS (steps 102,103). Subsequent to the step of configuring the pair of devices, a determination is made as to whether the source device has a MPS exceeding the destination device MPS, as indicated in step 104.

If the source device MPS exceeds the destination device MPS, the packet being sent from the source device is divided into a plurality of sub-packets each having a maximum payload size based on the MPS of the destination device, as indicated in step 106. The sub-packets are then transmitted to the destination device so that the packet can be delivered to the destination device which has a smaller MPS than the source device (step 107). If, however, the source device MPS does not exceed the destination device MPS, then the packet is transmitted as a single unit to the destination device as indicated in step 105. Thereafter the packet transfer is complete (step 108). Those skilled in the art would understand that method steps 101-103 could be performed in a different sequence from that shown in FIG. 1. For example method steps 102,103 could be performed prior to method step 101.

By configuring a pair of devices to transmit/receive packets with the respective MPS of the devices and dividing the packet being switched into sub packets based on the destination device MPS if the source device MPS exceeds the destination device MPS, the devices of the system supporting different MPS are capable of transmitting/receiving data with their different MPS and are not limited to transferring data with payload sizes which are smaller than can be supported by some of the devices.

Thus, the method 100 enables packets of data to be selectively switched between a source device, such as root complex device, and a destination device, such as endpoint device, in a manner that enhances the data transfer performance of the PCI-Express bus system.

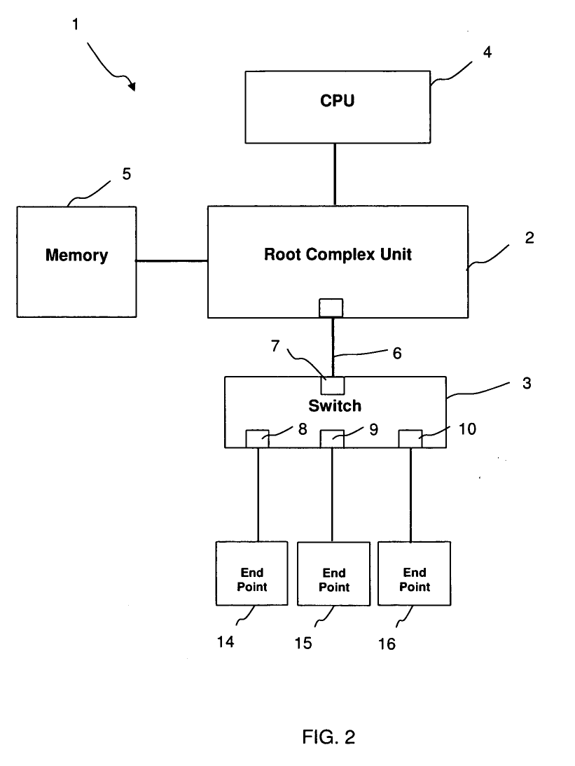

Method 100 of the illustrative embodiment can be implemented by different PCI Express based bus systems. A system suitable for implementing the method of transferring data between devices connected to a PCI-Express bus according to one embodiment is shown in FIG. 2. The system 1 is incorporated into a computer such as for example a Personal Computer (PC) or server. A CPU 4, memory 5, and end point devices 14, 15, 16 intercommunicate over different or similar buses via root complex device 2. Endpoint devices 14, 15, 16 are connected to the root complex device 2 by a PCI-Express bus 6 via a switch device 3. An operating system runs on the CPU and may be a commercially available operating system. Instructions for the operating system and applications or programs are stored in storage devices, such as a hard drive.

In the illustrative embodiment of FIG. 2, system 1 includes a plurality of selectable source and destination devices pairs, such as for example root complex device 2 and endpoint device 14 or, in the case of peer to peer communications, endpoint device 14 and endpoint device 15. The source device, for example root complex device 2, is configured by the root complex device to transfer data with a MPS supported by the source device whereas the destination device, for example endpoint device 14, is configured to transfer data with a MPS supported by the destination device. Switch device 3 interconnects the pair of devices for switching packets between the pair of devices. The switch device 3 includes a packet divider 10, such as one or more packet buffers, for dividing packets into a plurality of sub-packets. As will be explained in more detail below, the packet divider 10 is configured to divide a packet sent to the switch device 3 from the source device into a plurality of sub-packets if the source device MPS exceed the destination device MPS. Each of the sub packets have a maximum payload size based on the MPS of the destination device. The switch device transmits the sub-packets, or the original packet, from the divider to the destination device.

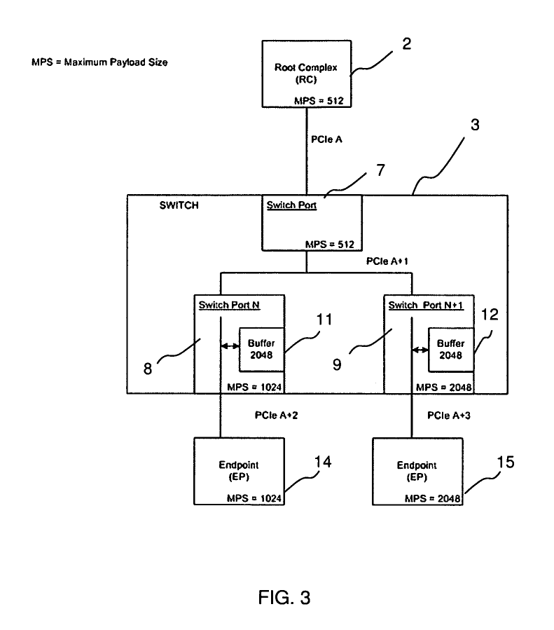

Referring now to the switch device 3 in more detail, as best shown in FIG. 3, the switch device 3 has a first switch port 7 operably coupled to the root complex device 2 and a plurality of second switch ports 8, 9 operably coupled to respective endpoint devices 14, 15. In the illustrative embodiment, the divider 10 comprises a plurality of packet buffers 11, 12, operably coupled to respective second switch ports 8, 9, for receiving and transmitting packet data via the second switch ports. For the sake of clarity, switch device 3 is shown in FIG. 3 as having a single first switch port 7 and only a pair of second switch ports 8, 9 connected to respective endpoint devices 14, 15, however, switch device 3 can have any number of second switch port and associated buffers and endpoint devices.

Switch device 3 provides the PCIe connectivity between an upstream device, for example the Root Complex device 2, and downstream devices, for example endpoint devices 14, 15, and additionally between downstream devices (peer-to-peer). PCIe Configuration Registers (not shown) allow switch device 3 and endpoints 14, 15 to advertise their MPS capability and to be programmed with a MPS for packet transfers. The Root complex device 2 is operable by a flow control program to read all the configuration space of the switch device 3 and endpoints 14,15, known as the discovery phase, and to program (enumerate) the switch device 3 and endpoints to match the MPS of each switch port 7,8,9 to an associated root complex device or endpoint device 2,14,15.

The MPS for each switch port and endpoint pair or each switch port and root complex pair on a PCIe bus are programmed for the Smallest MPS for the pair instead of the Smallest MPS of a device in the system. The switch device 3 is then responsible for the management of Read Completion and Posted Write type operations (CP type operations) involving transfer of Read completion Packet, Memory Write Request packet and/or Message Request Packets and guarantees to not exceed the MPS of the recipient of the packets. Different payload sizes are therefore available for each of the Switch PCIe busses.

The system is responsible for generating multiple Read Completions, Memory Write Requests or Message Requests packets when the MPS of the recipient of the data is less than the Payload Size of the source of the data. The switch device 3 manages Multiple Read Completions that need to be generated when a read completion packet exceeds the MPS of the destination device. The rules for Multiple Read Completions are the same as the PCI Express specification rules for completions. Switch device 3 may generate Multiple Read Completions when the device sourcing the Read Completion packet has a Payload Size that is greater than the MPS of the device receiving the Read Completion data.

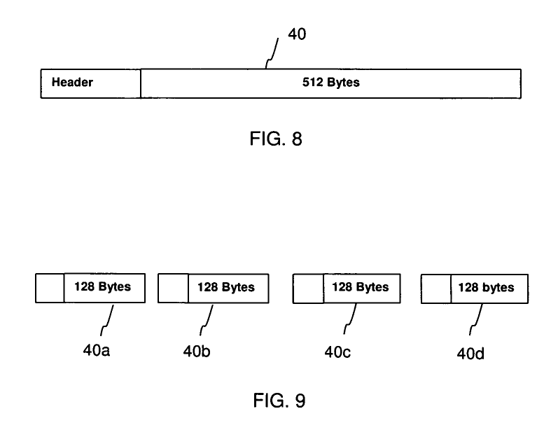

The switch device 3 also generates multiple Memory Write requests when the Memory Write Request packet exceeds the MPS of the destination device. The resulting Multiple Memory Write Requests are divided based on the MPS of the destination device. For example, a Memory Write request with a payload of 512 bytes targeted to a device with a MPS of 128 bytes is divided into four packets of 128 bytes each. FIG. 8 illustrates an example of a 512 byte message request packet 40 which can be transferred using the system of FIG. 3, and FIG. 9 illustrates four 128 byte sub-packets 40a-40d following division of the message request packet 40. The first bytes enables and starting address are provided in the header of the first packet 40a. The address for each subsequent packet is the address of the previous packet plus the number of Dwords transferred in the previous packet. The byte enables for intermediate packets are set to all ones. The last byte enable is provided in the header of the last packet 40d. The length field of the header indicates the number of Dwords transferred in the packet payload. All other header fields of the Multiple Write Requests are unmodified from the original header. Memory Write requests that are divided into multiple Memory Write requests must not allow any other transfers to pass this transfer once the transfer has started.

Message Requests that exceed the MPS of the receiver are generated with the same method as multiple Memory Write Requests. The length field of the header indicates the number of Dwords transferred in the packet payload. All other header fields of the Multiple Message Requests are unmodified from the original header. Message requests that are divided into multiple Message requests must not allow any other transfers to pass this transfer once the transfer has started.

Known PCI-Express bus systems are not capable of transferring data according to the method and system of the illustrative embodiments. In such PCI-Express bus systems, all the devices connected to the bus system are limited to transferring data with a pay load size which is supportable by all of the devices. The PCI Express (PCIe) specification does not generally allow source and destination devices of PCIe packet transfers to have different Maximum Packet Payload Sizes because this can lead to malformed packet errors. The PCIe supports maximum payload sizes from 128 to 4096 bytes. PCIe specification requires that the MPS transferred between a source and a destination device be equal to the smallest MPS supported by either device.

For example: if device A indicates a supported MPS of 128 bytes and device B indicates a supported MPS of 4096 bytes then the Root Complex of known PCI-Express bus systems would program Device A and B to a MPS of 128 bytes. However, making the MPS of the transferred packet equal to the smallest MPS of the devices prevents the generation of malformed packet errors due to a device receiving a packet with a payload larger than it is capable of handling. In turn, having all the devices transfer data with a payload size smaller than can be supported by some device(s) in the system degrades the system performance.

By system 1 configuring a selected pair of devices to transfer packets with the respective MPS of the devices and dividing the packet being switched into sub packets based on the destination device MPS if the source device MPS exceeds the destination device MPS, the system 1 can transfer packets based on the smallest MPS of the pair of devices rather than having to limit the pair of devices to transferring data with the smallest MPS of all the devices in the system. The resultant larger packet sizes contain less overhead than multiple smaller packets thus improving system performance.

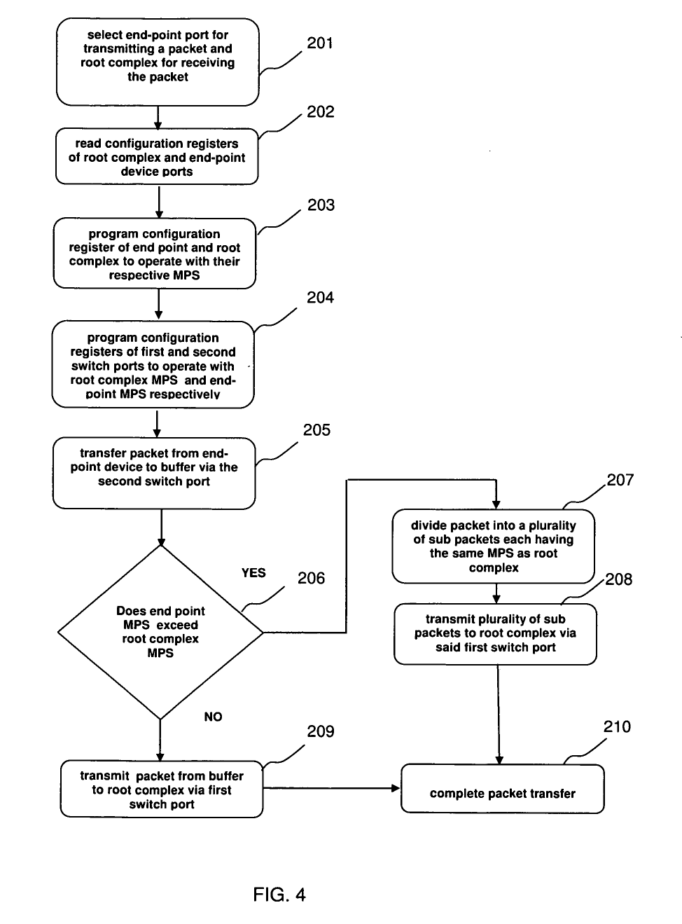

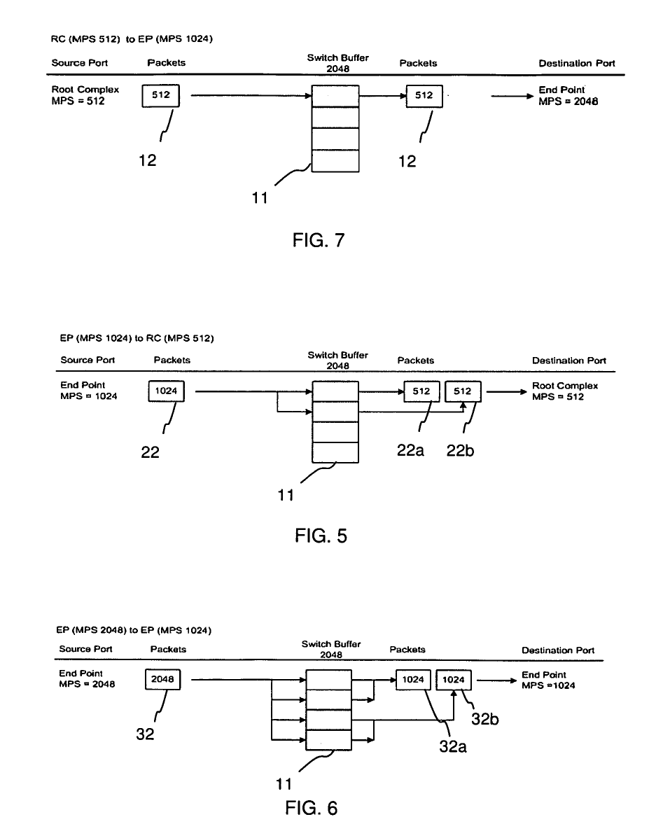

Methods of operating system 1 of FIG. 2 for transferring packets between selected source and destination devices will now be described. FIG. 4 illustrates a flow diagram outlining the system operation in which the selected device pair is an endpoint device functioning as a source device and the root complex device functioning as the destination device. FIGS. 5-7 illustrate examples of packet transfers for different packet payload sizes and device pairs having different MPS. For the purpose of illustration only, let us assume in a first example a 1024 byte packet 22 is being transferred from the end point device 14 to root complex device 2 and the MPS supported by the root complex device and the endpoint device are 1024 bytes and 512 bytes, respectively, as indicated schematically in FIG. 5. After initially selecting the endpoint device and root complex pair 14, 2, the configuration registers of the root complex device 2 and endpoint device 14 are read by the root complex device 2 to determine the respective MPS supported by each device (step 202). The MPS supported by the endpoint device and root complex device port are determined to be 512 bytes and 1024 bytes respectively. The root complex then programs the configurations registers of the endpoint device 14 and second switch port 8 coupled thereto so that the endpoint device 14 is capable of transferring data with a MPS of 1024 bytes to the switch device 3 and programs the configurations registers of the root complex device 2 and the first switch port 7 coupled thereto so that the switch device is capable of transferring data with a MPS of 512 bytes (steps 203, 204) to the root complex device (see also FIG. 3).

Thereafter the packet 22 is transferred from the endpoint device 14 to the buffer 11 via associated second switch port 8 (steps 205). Since the end point device MPS (1024 bytes) exceeds the root complex device MPS (512 bytes), the packet 22 stored in the buffer 11 is divided into a pair of sub packets 22a, 22b each having a data payload equal to 512 bytes, that is, equal to the MSP of the root complex device. As explained above, formats for the pair of 512 byte sub packets 22a, 22b vary according to whether the original packet 22 is a read completion packet, write request packet or message request packet. Thereafter, the pair of sub-packets 22a, 22b are consecutively transferred to the root complex device 2 via the first switch port 7 (step 208) completing the packet transfer. Those skilled in the art would appreciate that method steps 201-204 could be performed in a different sequence from that shown in FIG. 4. For example, method step 203 could be performed after method step 204 or method step 201 could be performed for example after method step 203.

Now lets us assume a 2048 byte packet 32 is being transferred from end point device 15 to endpoint device 14 and the MPS supported by the endpoint device 15 and the endpoint device 14 are 2048 bytes and 1024 bytes, respectively, as indicated in the schematic diagram of FIG. 6. After the configuration registers of the endpoint device 15 and end point device 14 are read by the root complex device 2 to determine the respective MPS supported by each device (step 202). The root complex then programs the configurations registers of the endpoint device 15 and second switch port 9 coupled thereto so that the endpoint device 15 is capable of transferring data with a MPS of 2048 bytes to the switch device 3 and programs the configurations registers of the endpoint device 14 and the first switch port 8 coupled thereto so that the switch device is capable of transferring data with a MPS of 1024 bytes (steps 203, 204) to the endpoint device.

Thereafter, packet 32 is transferred from the endpoint device 15 to the buffer 12 via associated second switch port 9 (step 205). Since the end point device MPS (2048 bytes) exceeds the endpoint device MPS (1024 bytes), the packet 32 is stored in the buffer 12 and is divided into a pair of sub packets 32a, 32b each having a data payload equal to 1024 bytes, that is, equal to the MPS of the endpoint device. Thereafter, the pair of sub-packets 32a, 32b are consecutively transferred to the endpoint via the first switch port 8 (step 208) completing the packet transfer (step 210).

FIG. 7 illustrates a further example in which a 512 byte packet 12 is being transferred from the root complex device 2 to end point device 15 and the MPS supported by the root complex device 2 and the endpoint device 15 are 512 bytes and 2048, respectively (see also FIG. 3). Since the root complex device port MPS does not exceed the endpoint device MPS, the packet 12 passes through the buffer 11 without division and is transferred to the endpoint device 15 via the second switch port thereby completing the packet transfer.

Those skilled in the art would understand that the method 100 for transferring packets between devices connected to a PCI-Express bus can be implemented in accordance with one or more alternative embodiments. For example, in an alternative embodiment, the method 100 can be implemented in a PCI-bus system in which the buffers and/or switch devices are integrated in the root complex device or in which the packet divider is separate from the switch and root complex. In such alternative embodiments of the method 100, the packet divider has a port for receiving the packet from the source device and another port for transmitting the packet or sub-packets to the destination device.

In accordance with additional alternative embodiments, the method described herein can further comprise configuring the MPS of the packer divider port for receiving the packet to equal the MPS of the source device and configuring the MPS of the packet divider port for transmitting the packet or sub-packets to equal the MPS of the destination device. Additionally, the method can comprise, storing the packet in the packet divider by transmitting the packet from the source device to the packet divider port for receiving the packet and transmitting the packet or sub-packets to the destination device from the packet divider port for transmitting the packet.

It will be appreciated that variations of the above-disclosed and other features, aspects and functions, or alternatives thereof, may be desirably combined into many other different systems or applications.

Also, it will be appreciated that various presently unforeseen or unanticipated alternatives, modifications, variations or improvements therein may be subsequently made by those skilled in the art which are also intended to be encompassed by the following claims.

What is claimed is:

1. A method of transferring packets between devices connected to a PCI-Express bus of a computer, the method comprising
selecting a pair of said devices comprising a source device and a destination device;
configuring said source device and said destination device to transmit/receive data with the maximum payload size (MPS) supported by said source device and destination device, respectively; and
transmitting a packet from said source device to said destination device;
wherein said step of transmitting said packet comprises
dividing said packet into a plurality of sub-packets if the source device MPS exceeds the destination device MPS, each of said sub packets having a maximum payload size based on the MPS of said destination device; and
transmitting said sub-packets or packet to said destination device so that said packet is delivered to said destination device.

2. The method of claim 1, wherein the step of dividing said packet into said plurality of sub packets comprises storing said packet in a respective packet divider to provide said plurality of sub packets.

3. The method of claim 2, wherein each of said sub packets has a maximum payload size equal to the MPS of said destination device

4. The method of claim 2, wherein said packet comprises a read completion packet, a memory write request packet or a message request packet.

5. The method of claim 2, further comprising interconnecting said selected pair of devices via a PCI-Express switch device having said packet divider integrated therein.

6. The method of claim 5, wherein said switch device further comprises a switch port for receiving said packet from said source device and another switch port for transmitting said packet or sub-packets to said destination device and wherein said respective packet divider comprises a buffer operably coupled to one of said switch ports.

7. The method of claim 6, further comprising the steps of
configuring the MPS of said switch port for receiving said packet to equal the MPS of said source device; and
configuring the MPS of said switch port for transmitting said packet or sub-packets to equal the MPS of said destination device.

8. The method of claim 7, wherein the step of transmitting said packet from said source device to said destination device further comprises the steps of
transmitting said packet from said source device to said switch port for receiving said packet;
storing said packet in said packet buffer; and
wherein the step of transmitting said sub-packets or packet to said destination device comprises
delivering said plurality of sub-packets or packet from said packet buffer to said destination device via said switch port for transmitting said packet.

9. The method of claim 8, wherein said selected pair of devices comprise a root complex device and an endpoint device or wherein said selected pair of devices comprises a pair of endpoint devices.

10. The method of claim 9, wherein the step of selecting said pair of devices comprises selecting said pair of devices from a plurality of devices connected to said switch device, said plurality of devices comprising a root complex device and a plurality of end point devices.

11. A system for transferring packets between devices connected to a PCI-Express bus of a computer, the system comprising
at least one pair of devices comprising a source device and a destination device each configured to operate at the device MPS;
a PCI-Express switch for selectively switching a packet between said devices; and
a packet divider operably coupled to or integrated in said PCI-Express switch for dividing said packet into a plurality of sub-packets for transmission to said destination device,
wherein, said packet divider is configured to divide said packet sent thereto from said source device into a plurality of sub-packets if said source device MPS exceeds the destination device MPS, each of said sub packets having a maximum payload size based on the MPS of said destination device.

12. The system of claim 11, wherein each of said sub packets has a maximum payload size equal to the MPS of said destination device.

13. The system of claim 11, wherein said PCI express switch includes switch ports for receiving and transmitting said packet, wherein said devices of the or each device pair are respectively coupled to said switch ports, and wherein said packet divider comprises at least one packet buffer, the or each said packet buffer being operably coupled to one of said switch ports associated with the or each device pair.

14. The system of claim 13, wherein said devices comprise a root complex device and at least one endpoint device and wherein said pair of devices comprises a root complex device and an endpoint device or wherein said pair of devices comprises a pair of endpoint devices.

15. The system of claim 13, wherein the or each buffer is operably connected to the same switch port as the or each endpoint device.

16. The system of claim 13, wherein said root complex is operable to configure the MPS of said switch port for receiving said packet to equal the MPS of said source device and to configure the MPS of said switch port for transmitting said packet to equal the MPS of said destination device.

17. A computer program product comprising: a computer-usable data carrier storing instructions that, when executed by a computer, cause the computer to perform a method of transferring packets between devices connected to a PCI-Express bus of said computer, the method comprising
selecting a pair of said devices comprising a source device and a destination device;
configuring said source device and said destination device to transmit/receive data with the maximum payload size (MPS) supported by said source device and destination device, respectively; and
transmitting a packet from said source device to said destination device;
wherein said step of transmitting said packet comprises
dividing said packet into a plurality of sub-packets if the source device MPS exceeds the destination device MPS, each of said sub packets having a maximum payload size based on the MPS of said destination device; and
transmitting said sub-packets or packet to said destination device so that said packet is delivered to said destination device.

18. The method of claim 17, wherein dividing said packet into said plurality of sub packets comprises storing said packet in a packet divider to provide said plurality of sub packets.

19. The method of claim 18, wherein each of said sub packets has a maximum payload size equal to the MPS of said destination device.

20. The method of claim 19, further comprising interconnecting said selected pair of devices via a PCI-Express switch device having said packet divider integrated therein.
